(19) United States
(12) Patent Application Publication
(10) Pub. No.: US 2007/0241683 A1
(43) Pub. Date: Oct. 18, 2007

(54) Plasma display panel

(76) Inventors: Kyoung-Doo Kang, Suwon-si (KR); Won-Ju Yi, Suwon-si (KR); Ho-Young Ahn, Suwon-si (KR); Soo-Ho Park, Suwon-si (KR); Seok-Gyun Woo, Suwon-si (KR); Jae-Ik Kwon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/783,976

(22) Filed: Apr. 13, 2007

(30) Foreign Application Priority Data
Apr. 14, 2006 (KR) 10-2006-0034178

(51) Int. Cl. H01J 17/49

(52) U.S. Cl. 313/582; 313/584; 313/586

(57) ABSTRACT

A plasma display panel includes first and second substrates parallel to one another, first barrier ribs between the first and second substrates to define a plurality of discharge cells, the first barrier ribs including a rough surface between the first substrate and the first barrier ribs, and a plurality of pairs of discharge electrodes in the first barrier ribs.

### BACKGROUND OF THE INVENTION

1. Field of the Invention

The present invention relates to a plasma display panel. In particular, the present invention relates to a plasma display panel exhibiting reduced reflective brightness.

2. Description of the Related Art

Plasma display panels (PDP) are flat display panels capable of displaying images using gas discharge phenomenon, thereby providing superior display properties such as high brightness and contrast, lack of residual image, wide viewing angles, and a thin display structure.

The conventional PDP may include first and second substrates with a plurality of sustain and address electrodes therebetween, dielectric layers on the electrodes, a plurality of barrier ribs, and light emitting phosphor layers coated onto sidewalls of the barrier ribs. In particular, the plurality of sustain electrodes, a dielectric layer, and a protective layer may be sequentially disposed on the first substrate.

However formation of layers and/or elements on the first substrate may minimize transmittance of visible light therethrough. More particularly, the sustain electrodes, dielectric layer, and protective layer may absorb visible light generated by the PDP and, thereby, reduce light transmission to the exterior of the PDP.

Additionally, the structure of the conventional barrier ribs facilitates reflection of external light therefrom and, thereby, increases reflective brightness. The increased reflective brightness may reduce bright room contrast which, in turn, may deteriorate the display quality of the PDP.

Accordingly, there exists a need to provide a PDP with a structure capable of reducing reflective brightness.

### SUMMARY OF THE INVENTION

The present invention is therefore directed to a plasma display panel (PDP), which substantially overcomes one or more of the disadvantages of the related art.

It is therefore a feature of an embodiment of the present invention to provide a PDP having a reduced reflective brightness.

At least one of the above and other features and advantages of the present invention may be realized by a plasma display panel including first and second substrates parallel to one another, first barrier ribs between the first and second substrates to define a plurality of discharge cells, the first barrier ribs including a rough surface between the first substrate and the first barrier ribs, and a plurality of pairs of discharge electrodes in the first barrier ribs. The rough surface may have a surface roughness of about 0.1 μm to about 5 μm.

Each of the plurality of pairs of discharge electrodes may include a first discharge electrode and a second discharge electrode spaced apart from each other and directed in perpendicular directions, so that each of the first and second discharge electrodes surrounding at least a portion of each of the discharge cells along a length of the discharge electrode. Alternatively, each of the plurality of pairs of discharge electrodes may include a first discharge electrode and a second discharge electrode spaced apart from each other and directed in parallel directions, so that each of the first and second discharge electrodes surrounds at least a portion of each of the discharge cells along a length of the discharge electrode. As such, the PDP may include a plurality of address electrodes spaced apart from each and directed in a direction perpendicular to a direction of the plurality of pairs of discharge electrodes, so that each address electrode is positioned between a first and a second discharge electrode and surrounds at least a portion of each of the discharge cells along the address electrode.

Each discharge cell may be between a first discharge electrode of one pair of discharge electrodes and a second discharge electrode of another pair of discharge electrodes of the plurality of pairs of discharge electrodes. The PDP may further include a plurality of address electrodes, so that each address electrode may be directed perpendicularly to the first and second discharge electrodes.

The PDP may also include second barrier ribs between the first barrier ribs and the second substrate. Additionally, the PDP may include phosphor layers on portions of sidewalls of the second barrier ribs. Alternatively, the PDP may include a plurality of grooves either in the first substrate or the second substrate, the grooves being adjacent to the discharge cells. The PDP may include phosphor layers in the plurality of grooves. I yet another alternative, the first and second substrates may include a plurality of first and second grooves, respectively, each of the first and second grooves being adjacent to a discharge cell. First and second phosphor layers may be included in the first grooves and second grooves, respectively.

In another aspect of the present invention, there is provided a plasma display panel (PDP), including first and second substrates parallel to each other, and an electrode sheet including first barrier ribs between the first and second substrates to define a plurality of discharge cells and a plurality of pairs of discharge electrodes in the first barrier ribs, wherein a surface of the electrode sheet adjacent to the first substrate is a rough surface. The rough surface may have a surface roughness of about 0.1 μm to about 5 μm.

Each of the plurality of pairs of discharge electrodes may include a first discharge electrode and a second discharge electrode spaced apart from each other, so that each of the first and second discharge electrodes may surround at least a portion of each of the discharge cells along a length of the discharge electrode. The PDP may further include a plurality of address electrodes spaced apart from each and directed in a direction perpendicular to a direction of the plurality of pairs of discharge electrodes, so that each address electrode may be positioned between a first and a second discharge electrode and surround at least a portion of each of the discharge cells along the address electrode. Each discharge cell may be between a first discharge electrode and a second discharge electrode of the plurality of discharge electrodes.

The PDP may additionally include second barrier ribs between the first barrier ribs and the second substrate and phosphor layers on sidewalls of the second barrier ribs. Further, the PDP may include a plurality of grooves with phosphor layers in the first and second substrates, each groove being adjacent to a discharge cell.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partially exploded perspective view of a plasma display panel according to an embodiment of the present invention;

FIG. 2 illustrates a partial cross-sectional view taken along line II-II of FIG. 1;

FIG. 3 illustrates a schematic diagram of discharge cells and first and second discharge electrodes of the plasma display panel illustrated in FIG. 1;

FIG. 4 illustrates a partial cross-sectional view of a plasma display panel according to another embodiment of the present invention;

FIG. 5 illustrates a schematic diagram of discharge cells, first and second discharge electrodes, and address electrodes of the plasma display panel illustrated in FIG. 4;

FIG. 6 illustrates a partial cross-sectional view of a plasma display panel according to another embodiment of the present invention; and

FIG. 7 illustrates a partial cross-sectional view taken along a line VII-VII of FIG. 6, according to an embodiment of the present invention.

### DETAILED DESCRIPTION OF THE INVENTION

Korean Patent Application No. 10-2006-0034178, filed on Apr. 14, 2006, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer, element or substrate, it can be directly on the other layer or substrate, or intervening layers or elements may also be present.

Further, it will be understood that when a layer or element is referred to as being “under” another layer or element, it can be directly under, or one or more intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

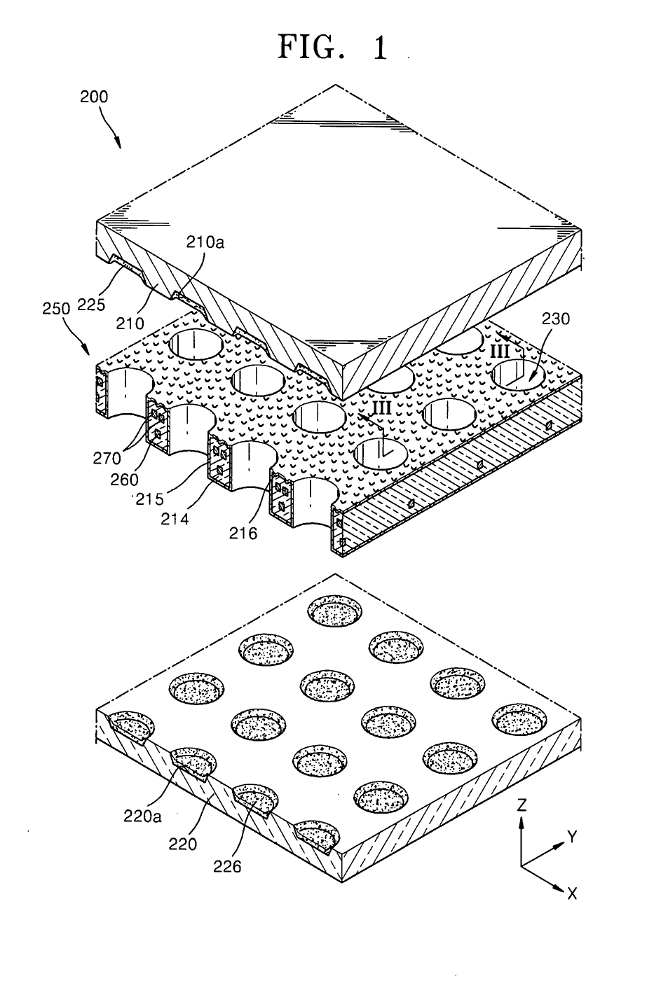

Hereinafter, an exemplary embodiment of a plasma display panel (PDP) according to the present invention will be described more fully with reference to FIGS. 1-3.

As illustrated in FIG. 1, a plasma display panel (PDP) 200 according to an embodiment of the present invention may include a first substrate 210, a second substrate 220, an electrode sheet 250, first phosphor layers 225, and second phosphor layers 226.

The first and second substrates 210 and 220 may be formed of a material having excellent light transmission properties, e.g., glass, and be colored in order to increase the bright room contrast by reducing reflective brightness. The first and second substrates 210 and 220 may be spaced apart from one another to define a discharge space with a plurality of discharge cells 230 therebetween. Additionally, the first and second substrates 210 and 220 may include first and second grooves 210a and 220a, respectively, selectively formed in portions of respective substrates, so that each discharge cell 230 may correspond to one first groove 210a in the first substrate and one second groove 220a in the second substrate 220. Each of the first and second grooves 210a and 220a may be formed to correspond to a single discharge cell 230 or to a plurality, e.g., an array, of discharge cells 230. Without intending to be bound by theory, it is believed that formation of the first grooves 210a in the first substrate 210 may reduce a thickness, i.e., a distance as measured along the z-axis, of the first substrate 210 and, thereby, improve transmittance rate of visible light therethrough.

The electrode sheet 250 of the PDP 200 according to an embodiment of the present invention may include a plurality of pairs of first and second discharge electrodes 260 and 270, respectively, and barrier ribs 214 partitioning the discharge space between the first and second substrates 210 and 220 into the plurality of discharge cells 230. The surface of the electrode sheet 250 may have a curved cross-section.

The plurality of pairs of first and second discharge electrodes 260 and 270 of the electrode sheet 250 according to an embodiment of the present invention may be disposed in the barrier ribs 214, such that each of the first discharge electrodes 260 may be paired with a respective second discharge electrode 270 to generate discharge in the discharge cells 230 positioned therebetween. The plurality of pairs of first and second discharge electrodes 260 and 270 may serve as scan/sustain electrodes and address/sustain electrodes, e.g., first discharge electrodes 260 may operate as scan/sustain electrodes, and the second discharge electrodes 270 may operate as address/sustain electrodes, or vice versa.

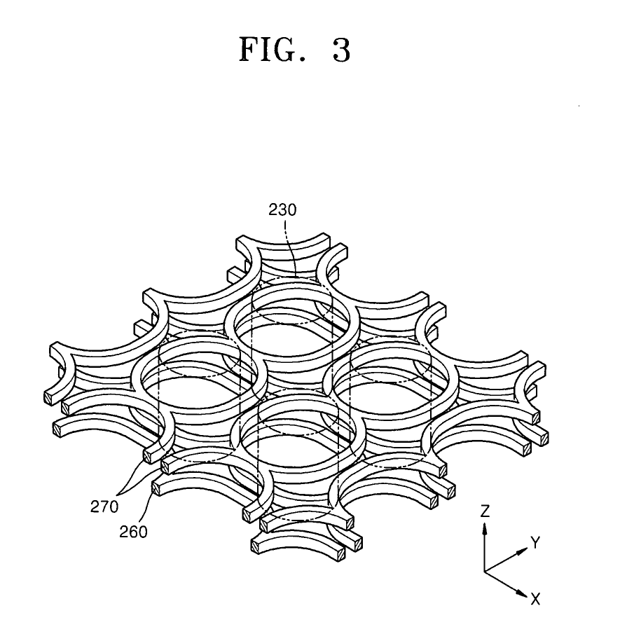

More specifically, as illustrated in FIG. 3, each of the first discharge electrodes 260 may include a plurality of tangential identical circles arranged sequentially into a single linear array along the x-axis, such that each circle of the plurality of circles may surround a single discharge cell 230. The plurality of first discharge electrodes 260 may be arranged parallel to one another, such that a small gap may be formed between every two first discharge electrodes 260. In this respect, it should be noted that “tangential circles” refer to circles that may touch one another at only one point, such that no other intersecting points may be formed between the circles, i.e., a cross-section along a tangent point of two circles may show a single point of contact.

Similarly, as further illustrated in FIG. 3, each of the second discharge electrodes 270 may include a plurality of tangential identical circles arranged sequentially into a single linear array along the y-axis, such that each second discharge electrode 270 may be positioned at a right angle to the plurality of first discharge electrodes 260. Each circle of the plurality of circles of each second discharge electrode 270 may be positioned above a respective circle of a respective first discharge electrode 260 to surround a discharge cell 230, such that each discharge cell 230 may be surrounded by two electrode circles. The plurality of second discharge electrodes 270 may be arranged parallel to one another, such that a small gap may be formed between every two second discharge electrodes 270. Additionally, a plane formed by the plurality of the second discharge electrodes 270 may be adjacent and parallel to a plane formed by the first discharge electrodes 260. Further, the planes of the first and second discharge electrodes 260 and 270 may have a gap therebetween along the z-axis, as illustrated in FIG. 3.

In this respect, it should be noted that even though the present embodiment, illustrated with respect to FIG. 3, includes identical circles, wherein the first discharge electrode 260 is positioned below the second discharge electrode 270, other configurations of electrode shapes and positions are not excluded from the scope of the present invention. For example, the plurality of the first discharge electrodes 260 may be positioned above the plurality of the second discharge electrodes 270.

The first and second discharge electrodes 260 and 270 may be formed of a conductive metal, e.g., aluminum, copper, and so forth. Accordingly, and without intending to be bound by theory, it is believed that small voltage drops in the directions of the first and second discharge electrodes 260 and 270, i.e., x-axis and y-axis, may stabilize signal transmission.

Additionally, formation of the first and second discharge electrodes 260 and 270 in the barrier ribs 214, as opposed to formation thereof on the first substrate 210, may be advantageous in minimizing a number of light absorbing elements on the substrate 210. In particular, formation of the first and second discharge electrodes 260 and 270 in the barrier ribs 214 may minimize blocking of visible light and, thereby, increase transmittance thereof. Further, the barrier ribs 214 may prevent direct electrical conduction between the first and second discharge electrodes 260 and 270, and, thereby, minimize collision of positive ions or electrons therewith in order to reduce potential damage to the first and second discharge electrodes 260 and 270.

The barrier ribs 214 of the electrode sheet 250 according to an embodiment of the present invention may be formed such that the discharge cells 230 may have any cross section as determined by one of ordinary skill in the art, e.g., circular, tetragonal, pentagonal, delta-patterned, and so forth. The barrier ribs 214 may include a rough surface 216 and a plurality of protective layers 215 formed on portions of sidewalls of the barrier ribs 214.

The rough surface 216 of the barrier ribs 214 according to an embodiment of the present invention may be formed on a surface of the barrier ribs 214, such that the rough surface 216 may be between the barrier ribs 214 and the first substrate 210. The rough surface 216 may be formed by any method as determined by one of ordinary skill in the art, e.g., sandblasting the surface of the barrier ribs 214, pressing a rough surfaced member to the surface of the barrier ribs 214 prior to baking of the electrode sheet 250, and so forth, to have a surface roughness of about 0.1 μm to about 5 μm. The surface roughness of the rough surface 216 may be determined by measuring height irregularities, e.g., bumps, on the rough surface 216 with respect to a predetermined reference line and calculating a root mean square value of the measured height irregularities. The root mean square value is the surface roughness.

Without intending to be bound by theory, it is believed that the formation of the rough surface 216 is advantageous in reducing reflection of internal and external light. In particular, external light incident on the barrier ribs 214 may be diffuse-reflected away from the rough surface 216 and, thereby, reduce the amount of light reflected in one direction due to light scattering. Additionally, when visible light generated by the PDP is transmitted to an exterior of the PDP, the visible light may be incident on the rough surface 216 and be diffuse-reflected several times to reduce the amount of reflection further.

The protective layers 215 of the electrode sheet 250 according to an embodiment of the present invention may be formed by coating magnesium oxide (MgO) on portions of the sidewalls of the barrier ribs 214 to minimize damage to the barrier ribs 214 from plasma particles. Also, the protective layers 215 may generate secondary electrons to reduce discharge voltage.

The first light-emitting phosphor layers 225 may be coated onto each of the first grooves 210a of the first substrate 210 and include red, green, and blue light emitting phosphor materials. Similarly, the second light-emitting phosphor layers 226 may be coated onto each of the second grooves 220a of the second substrate 220 and include red, green, and blue light-emitting phosphor materials. The coating area of the first and second phosphor layers 225 and 226 in each of the first and second grooves 210a and 220a, respectively, may be higher as compared to a PDP having first and second substrates without grooves and, thereby, provides increased brightness and light-emitting efficiency. The first and second phosphor layers 225 and 226 may include a red light emitting phosphor, e.g., Y(V,P)O₄:Eu, a green light emitting phosphor, e.g., Zn₂SiO₄:Mn and YBO₃:Tb, and a blue light emitting phosphor, e.g., BAM:Eu.

The PDP 200 according to an embodiment of the present invention may further include a discharge gas, e.g., neon (Ne), xenon (Xe), or a mixture thereof, in the discharge cells 230.

An exemplary method of manufacturing the PDP 200 is as follows. First, the first and second substrates 210 and 220 may be prepared. In particular, the first and second substrates 210 and 220 may be etched or sandblasted to form the first and second grooves 210a and 220a, respectively. Next, phosphor pastes may be applied onto the first and second grooves 210a and 220a, followed by drying and baking procedures to form the first and second phosphor layers 225 and 226 in the first and second grooves 210a and 220a, respectively.

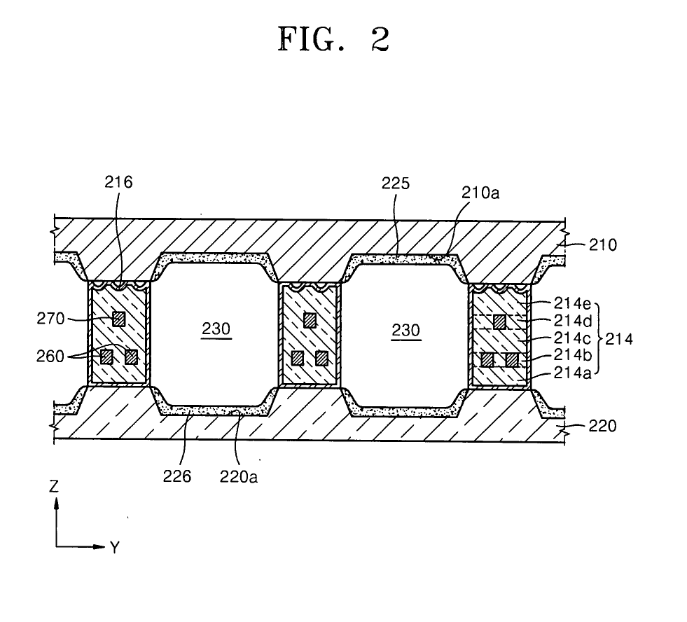

Subsequently, the electrode sheet 250 may be manufactured by any method as determined by one of ordinary skill in the art. For example, as illustrated in FIG. 2, a plurality of dielectric sheets may be prepared to form the barrier ribs 214. In particular, the first and second discharge electrodes 260 and 270 may be formed in second and fourth dielectric sheets 214b and 214d, respectively. Next, first, third, and fifth dielectric sheets 214a, 214c and 214e may be formed. Subsequently, the first through fifth dielectric sheets 214a, 214b, 214c, 214d and 214e may be sequentially stacked, dried and fired to finalize formation of the barrier ribs 214.

The barrier ribs 214 may be formed and arranged to have discharge cells 230 therebetween. Once the barrier ribs 214 are formed, one surface thereof may be processed, e.g., sandblasted, to form the rough surface 216. Next, the protective layers 215 may be deposited onto inner sidewalls of the barrier ribs 214.

Once the electrode sheet 250 and first and second substrates 210 and 220 are formed, the first substrate 210 and the second substrate 220 may be attached to one another with frit glass, such that the electrode sheet 250 may be positioned therebetween. Finally, impurities may be exhausted from the PDP 200, while discharge gas may be injected therein to complete manufacturing of the PDP 200.

An exemplary method of operating the plasma display panel 200 according to an embodiment of the present invention is as follows. First, an address discharge may be generated between the first and second discharge electrodes 260 and 270 to select discharge cells 230 to be operated, i.e., discharge cells 230 to emit light. Next, a sustain voltage may be applied between the first and second discharge electrodes 260 and 270 of the selected discharge cells 230 to generate a sustain discharge therebetween. The sustain discharge may excite the discharge gas in the discharge cells 230 to emit ultraviolet (UV) rays and, subsequently, excite the first phosphor layers 225 to emit visible light.

Without intending to be bound by theory, it is believed that the inventive structure of the PDP 200 and the driving method thereof is advantageous because the sustain discharge in the PDP 200 may occur on all sides of the barrier ribs 214, as opposed to a conventional PDP having a sustain discharge perpendicularly to the first substrate. The sustain discharge in the present invention may diffuse toward center portions of the discharge cells 230 and increase the discharge area and volume as compared to the conventional PDP. It should further be noted that the occurrence of sustain discharge in the central portions of the discharge cells 230 may reduce ion sputtering of phosphor and, thereby, minimizing residual images in the PDP.

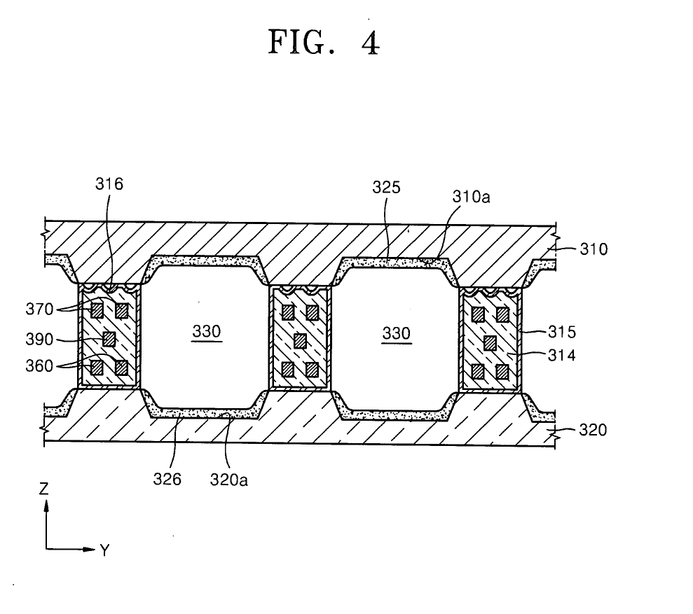

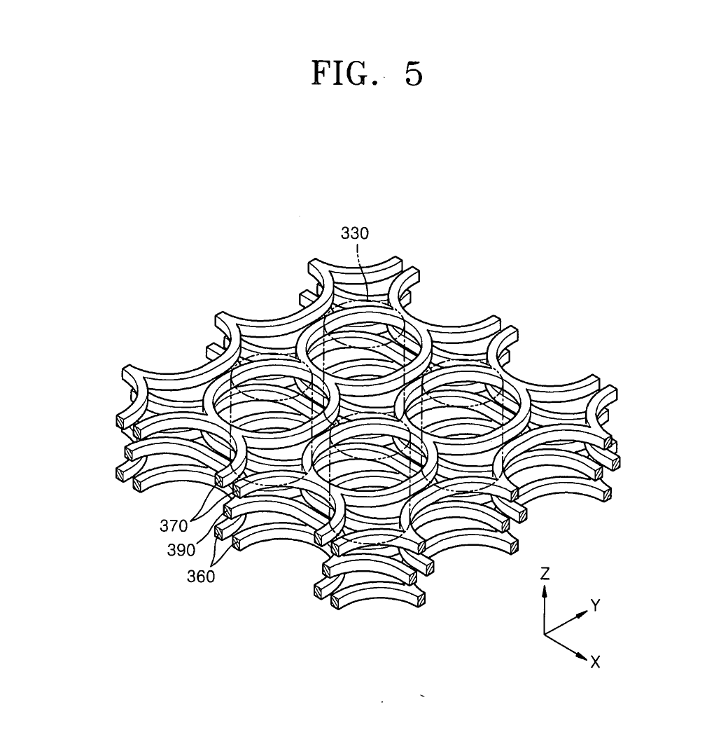

According to another embodiment of the present invention illustrated in FIGS. 4-5, a PDP 300 may be similar to the PDP 200 described previously with reference to FIGS. 1-3, with the exception that the PDP 300 may include a plurality of address electrodes 390.

In particular, the PDP 300 according to an embodiment of the present invention may include first and second substrates 310 and 320 with first and second grooves 310a and 320a, respectively, an electrode sheet 350 having discharge cells 330 therein, and first and second phosphor layers 325 and 326. Further, the electrode sheet 350 of the PDP 300 according to an embodiment of the present invention may include a plurality of barrier ribs 314 with protective layers 315, a rough surface 316 on the barrier ribs 314, a plurality of pairs of first and second discharge electrodes 360 and 370, and a plurality of address electrodes 390.

It is noted that the particular elements included in the embodiment illustrated in FIGS. 4-5 and their operation is similar to the description provided previously with respect to the PDP 200 illustrated in FIGS. 1-3. Accordingly, only details that may be distinguishable from the previous embodiment will be described hereinafter. It is further noted that reference numerals having identical last two digits refer to like elements and the first digits “2” and “3” are employed only for the purpose of distinguishing embodiments and not elements.

As illustrated in FIGS. 4-5, each of the first and second discharge electrodes 360 and 370 may include a plurality of tangential identical circles arranged sequentially into linear arrays along the x-axis, such that each circle of the plurality of circles may surround a single discharge cell 330. The plurality of first and second discharge electrodes 360 and 370 may be arranged similarly to the configuration described previously with respect to FIGS. 1-3. The plurality of pairs of first and second discharge electrodes 360 and 370 may serve as scan and sustain electrodes respectively. However, other electrode configurations are not excluded from the scope of the present invention.

As further illustrated in FIG. 5, each of the plurality of the address electrodes 390 may include a plurality of tangential identical circles arranged sequentially into a single linear array along the y-axis, such that each address electrodes 390 may be positioned at a right angle to the plurality of first and second discharge electrodes 360 and 370. Each circle of the plurality of circles of each address electrodes 390 may be positioned between respective circles of respective first and second discharge electrode 360 and 370 to surround a discharge cell 330, such that each discharge cell 330 may be surrounded by three concentric circles. The plurality of address electrodes 390 may be arranged parallel to one another, such that a small gap may be formed between every two address electrodes 390. Additionally, a plane formed by the address electrodes 390 may be parallel to, i.e., positioned in the xy-plane, and positioned between the planes formed by the first and second discharge electrodes 360 and 370.

In this respect, it should be noted that even though the present embodiment, illustrated with respect to FIGS. 4-5, includes identical circles, wherein the address electrodes 390 are positioned between the first and second discharge electrodes 260 and 270, other configurations of electrode shapes and positions are not excluded from the scope of the present invention. For example, the address electrodes 390 may be positioned adjacent to the first substrate 310, on the second substrate 320, and so forth.

Formation of the plurality of address electrodes 390 according to an embodiment of the present invention may facilitate generation of an address discharge to produce a sustain discharge between the first and second discharge electrodes 360 and 370 and, thereby, reduce an initial voltage of a sustain discharge.

Accordingly, the PDP 300 may be operated similarly to the PDP 200 described previously with respect to FIGS. 1-3, with the exception that the address discharge may be generated between the first discharge electrodes 360 and the address electrodes 390.

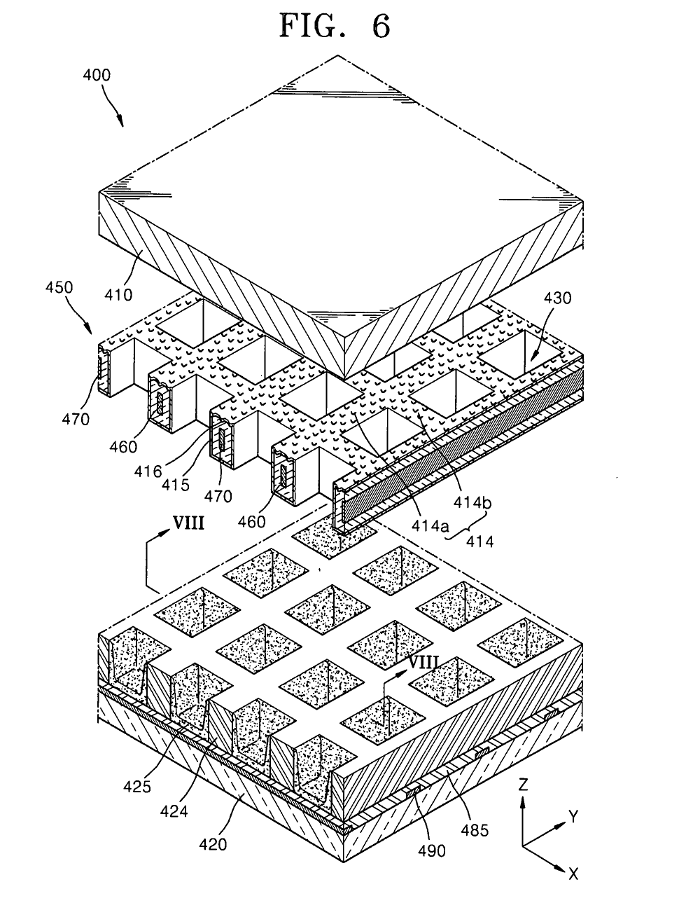

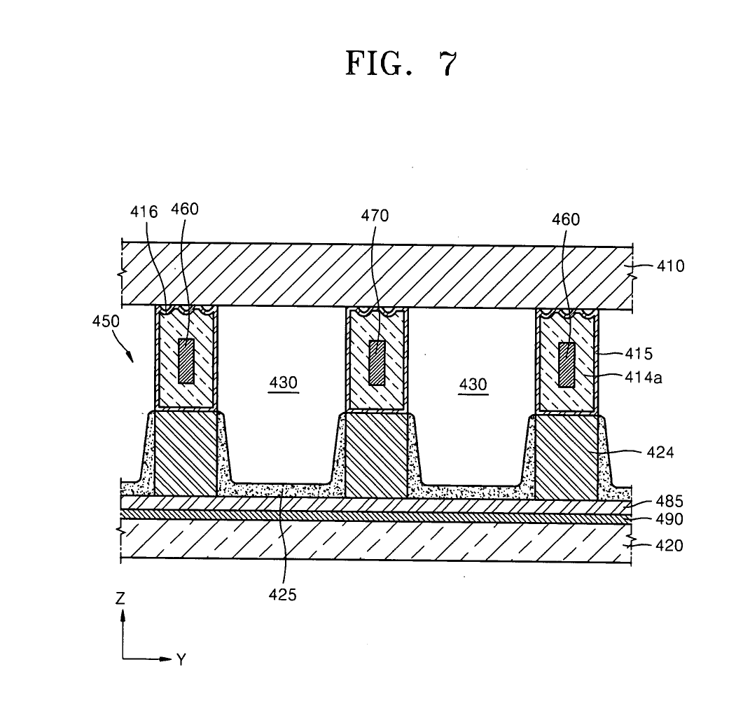

According to yet another exemplary embodiment of the present invention illustrated in FIGS. 6-7, a PDP 400 may include first and second substrates 410 and 420, an electrode sheet 450 disposed between the first substrate 410 and the second substrate 420 and having discharging cells 430 therein, and phosphor layers 425.

Further, the electrode sheet 450 may include first and second barrier ribs 414 and 424, respectively, a rough surface 416 on the first barrier ribs 414, a plurality of pairs of first and second discharge electrodes 460 and 470, and a plurality of address electrodes 490.

It is noted that the particular elements included in the embodiment illustrated in FIGS. 6-7 and their operation is similar to the description provided previously with respect to the PDPs 200 and 300 illustrated in FIGS. 1-5. Accordingly, only details that may be distinguishable from the previous embodiment will be described hereinafter. It is further noted that reference numerals having identical last two digits refer to like elements and the first digits “2,” “3” and “4” are employed only for the purpose of distinguishing embodiments and not elements.

The first barrier ribs 414 of the electrode sheet 450 according to an embodiment of the present invention may be adjacent to the first substrate 410 and may include vertical barrier rib parts 414a, e.g., directed along the y-axis, in parallel to the first discharge electrodes 460 and horizontal barrier rib parts 414b, e.g., directed along the x-axis, positioned perpendicularly to the vertical barrier rib parts 414a, so that the discharge cells 430 may have rectangular cross sections. However, other cross-sections are not excluded from the scope of the present invention. The first barrier ribs 414 may be coated with protective layers 415 on outer surfaces thereof.

The second barrier ribs 424 of the electrode sheet 450 according to an embodiment of the present invention may be disposed between the second substrate 420 and the first barrier ribs 414 to define spaces for coating the phosphor layers 425. The second barrier ribs 424 may have a substantially similar structural pattern as the first barrier ribs 414, so that the first and second barrier ribs 414 and 424 may be formed integrally.

The first and second discharge electrodes 460 and 470 of the electrode sheet 450 may be disposed in the vertical barrier rib parts 414a of the first barrier ribs 414, i.e., one electrode in each vertical barrier rib part 414a, and have a length, i.e., a distance as measured along the y-axis, substantially equal to a length of the electrode sheet 450. In particular, the first and second discharge electrodes 460 and 470 may alternate, so that each second discharge electrode 470 may be positioned between two first discharge electrodes 460 and in parallel thereto, i.e., form a stripe pattern. Accordingly, each discharge cell 430 may be positioned between one first discharge electrode 460 and one second discharge electrode 470. However, each of the first and second discharge electrodes 460 and 470 may correspond to more than one discharge cell 430, i.e., each of the first and second discharge electrodes 460 and 470 may be positioned in the vertical barrier rib parts 414a of the barrier ribs 414 and along an array of discharge cells 430, so widths, i.e., distances as measured along the x-axis, may be minimized.

The address electrodes 490 of the PDP 400 according to an embodiment of the present invention may be spaced apart from each other and disposed on the second substrate 420. The address electrodes 490 may be stripe-patterned and perpendicular to the first and second discharge electrodes 460 and 470. The address electrodes 490 may be coated with dielectric layers 485, so that the dielectric layers 485 may be disposed between the second substrate 420 and the first barrier ribs 414.

Edges of the first and second substrates 410 and 420 may be attached with a sealing member, e.g., frit glass, so that a discharge gas, e.g., neon (Ne), xenon (Xe), or a mixture thereof, may be sealed in the discharge cells 430.

A method of operating the PDP 400 may be similar to the driving method of the PDP 300 described previously with respect to FIGS. 4-5 and, therefore, will not be repeated herein.

The PDP according to an embodiment of the present invention may be advantageous in providing a rough surface on the barrier ribs capable of minimizing reflection of external light and, thereby, improve bright room contrast of the PDP.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
first and second substrates parallel to one another;
first barrier ribs between the first and second substrates defining a plurality of discharge cells, the first barrier ribs including a rough surface between the first substrate and the first barrier ribs ; and
a plurality of pairs of discharge electrodes in the first barrier ribs.

2. The PDP as claimed in claim 1, wherein the rough surface has a surface roughness of about 0.1 μm to about 5 μm.

3. The PDP as claimed in claim 1, wherein each of the plurality of pairs of discharge electrodes includes a first discharge electrode and a second discharge electrode spaced apart from each other and directed in perpendicular directions, each of the first and second discharge electrodes surrounding at least a portion of each of the discharge cells along a length of the discharge electrode.

4. The PDP as claimed in claim 1, wherein each of the plurality of pairs of discharge electrodes includes a first discharge electrode and a second discharge electrode spaced apart from each other and directed in parallel directions, each of the first and second discharge electrodes surrounding at least a portion of each of the discharge cells along a length of the discharge electrode.

5. The PDP as claimed in claim 4, further comprising address electrodes spaced apart from each other and substantially crossing the pairs of discharge electrodes, wherein the address electrodes surround at least a part of each of the discharge cells disposed along the address electrodes.

6. The PDP as claimed in claim 1, wherein each of the pairs of discharge electrodes includes a first discharge electrode and a second discharge electrode, which face each other toward inside the discharge cells in the first barrier ribs.

7. The PDP as claimed in claim 6, wherein the first discharge electrode and the second discharge electrode are parallel to each other,
further comprising: address electrodes substantially crossing the first discharge electrode and the second discharge electrode and formed on the first substrate or the second substrate.

8. The PDP as claimed in claim 1, further comprising second barrier ribs disposed between the first barrier ribs and the second substrate, and phosphor layers formed on portions of sidewalls of the second barrier ribs.

9. The PDP as claimed in claim 1, further comprising a plurality of grooves either in the first substrate or the second substrate, the grooves being facing the discharge cells.

10. The PDP as claimed in claim 9, further comprising phosphor layers in the plurality of grooves.

11. The PDP as claimed in claim 1, wherein the first and second substrates include a plurality of first and second grooves, respectively, the first and second grooves facing the discharge cells.

12. The PDP as claimed in claim 1, further comprising first phosphor layers in the first grooves and second phosphor layers in the second grooves.

13. A plasma display panel (PDP), comprising:
first and second substrates parallel to each other; and
an electrode sheet including first barrier ribs between the first and second substrates to define a plurality of discharge cells and a plurality of pairs of discharge electrodes in the first barrier ribs, wherein a rough surface is formed in at least a part of the first barrier ribs facing the first substrate.

14. The PDP as claimed in claim 13, wherein the rough surface has a surface roughness of about 0.1 μm to about 5 μm.

15. The PDP as claimed in claim 13, wherein each of the plurality of pairs of discharge electrodes includes a first discharge electrode and a second discharge electrode spaced apart from each other, each of the first and second discharge electrodes surrounds at least a portion of each of the discharge cells along a length of the discharge electrode.

16. The PDP as claimed in claim 15, further comprising a plurality of address electrodes spaced apart from each other and substantially crossing the pairs of discharge electrodes, wherein the address electrodes surround at least a part of each of the discharge cells disposed along the address electrodes.

17. The PDP as claimed in claim 13, wherein each discharge cell is between a first discharge electrode and a second discharge electrode of the plurality of discharge electrodes.

18. The PDP as claimed in claim 13, further comprising second barrier ribs between the first barrier ribs and the second substrate, and phosphor layers on sidewalls of the second barrier ribs.

19. The PDP as claimed in claim 13, further comprising a plurality of grooves formed on the first substrate or the second substrate facing the discharge cells.

20. The PDP as claimed in claim 19, further comprising phosphor layers formed in the grooves.
